(19) United States
(12) Patent Application Publication
(10) Pub. No.: US 2024/0220463 A1
(43) Pub. Date: Jul. 4, 2024

(54) METHOD FOR SIMULTANEOUSLY MODELING ELECTRICITY GENERATION DATA AND CONDUCTING VISUAL ANALYSIS

(71) Applicant: Three Gorges Hi-Tech Information Technology Co., Ltd, Wuhan (CN)

(72) Inventors: Wei GU, Wuhan (CN); Cheng XU, Wuhan (CN); Chen ZHANG, Wuhan (CN); Yunsheng XU, Wuhan (CN); Xiaosong GUO, Wuhan (CN); Yunfei SONG, Wuhan (CN); Yu XIAO, Wuhan (CN); Kehan LI, Wuhan (CN); Rendu XIONG, Wuhan (CN)

(73) Assignee: Three Gorges Hi-Tech Information Technology Co., Ltd, Wuhan (CN)

(21) Appl. No.: 18/513,336

(22) Filed: Nov. 17, 2023

Related U.S. Application Data
(63) Continuation of application No. PCT/CN2023/124554, filed on Oct. 13, 2023.

(30) Foreign Application Priority Data
Jan. 4, 2023 (CN) 202310006938.3

(51) Int. Cl. G06F 16/21; G06F 16/26; G06Q 10/04; G06Q 50/06

(52) U.S. Cl. CPC G06F 16/212; G06F 16/26; G06Q 10/04; G06Q 50/06

(57) ABSTRACT

A method for simultaneously modeling electricity generation data and conducting visual analysis includes steps of: retrieving target historical electricity generation data from a historical electricity generation database based on analysis requirement; constructing an optimal periodic distribution characteristic prediction model based on the target historical electricity generation data and an initial model, and obtaining predictive results based on the optimal periodic distribution characteristic prediction model; visualizing the optimal periodic distribution characteristic prediction model and the predictive results based on a communication link to obtain visual presentation results; analyzing and processing the visual presentation results based on a user-inputted secondary analysis instruction to obtain visual analysis results.

### CROSS-REFERENCE TO RELATED APPLICATION

This application is a continuation of International Application No. PCT/CN2023/124554, filed on Oct. 13, 2023, which claims priority to Chinese Patent Application No. 202310006938.3, filed on Jan. 4, 2023. All of the aforementioned applications are incorporated herein by reference in their entireties.

### TECHNICAL FIELD

The present disclosure relates to the technical field of data modeling, in particular, a method for simultaneously modeling electricity generation data and conducting visual analysis.

### BACKGROUND

At present, some modules such as electricity analysis, business travel theme and financial analysis have put forward the demand of making some trends and predictions on the basis of visualization, and such demand will gradually increase with the maturation of a big data platform. The characteristic of electricity generation data is its periodicity. Therefore, with regards to analyzing the periodic distribution characteristics of electricity generation data and accurately predict the electricity demand in the next cycle, it is imperative to perform modeling and analysis of historical electricity generation data on the foundation of visual analysis.

However, current visual tools solely provide plotting and presentation of detailed data, lacking components to build models such as linear regression, polynomial regression and logistic regression. The visual tools are not able to further analyze existing data and predict future data trends. The data modeling process can only be achieved by code programming.

Therefore, the present disclosure provides a method for simultaneously modeling electricity generation data and conducting visual analysis.

### SUMMARY

The present disclosure provides a method for simultaneously modeling electricity generation data and conducting visual analysis, which can be used to retrieve target historical electricity generation data from a historical electricity generation database based on analysis requirement, modeling data based on the target historical electricity generation data and an initial model and obtaining a prediction model capable of accurately predicting the time-evolving behavior of electricity generation data in the next cycle. The present disclosure also facilitates the visualization of results obtained from the prediction model concerning the best periodic distribution characteristics. Furthermore, it enables further analytical processing of the visual results based on user-inputted analysis instructions. In doing so, it seamlessly integrates data modeling and visual analysis for electricity generation data. This not only empowers analysis of existing electricity generation data and the prediction of temporal variations in future cycles but also facilitates the visual representation of electricity generation data.

The present disclosure provides a method for simultaneously modeling electricity generation data and conducting visual analysis, including:
S1, retrieving target historical electricity generation data from a historical electricity generation database based on analysis requirement;
S2, constructing an optimal periodic distribution characteristic prediction model based on the target historical electricity generation data and an initial model, and obtaining predictive results based on the optimal periodic distribution characteristic prediction model;
S3, visualizing the optimal periodic distribution characteristic prediction model and the predictive results based on a communication link to obtain visual presentation results;
S4, analyzing and processing the visual presentation results based on a user-input secondary analysis instruction to obtain visual analysis results.

Preferably, according to the method for simultaneously modeling electricity generation data and conducting visual analysis, S1: retrieving target historical electricity generation data from a historical electricity generation database based on analysis requirement includes:
S101: determining a target analysis data type and an analysis period based on the user-inputted analysis requirement;
S102: retrieving the target historical electricity generation data in the analysis period from the historical electricity generation database based on the target analysis data type.

Preferably, according to the method for simultaneously modeling electricity generation data and conducting visual analysis, S2: constructing an optimal periodic distribution characteristic prediction model based on the target historical electricity generation data and an initial model and obtaining predictive results based on the optimal periodic distribution characteristic prediction model includes:
S201, grouping the target historical electricity generation data to obtain a parameter-adjusted electricity generation data set and a test electricity generation data set;
S202, training the initial model based on a machine learning method and parameter-adjusted electricity generation data to obtain a periodic distribution characteristic prediction model;
S203, evaluating the periodic distribution characteristic prediction model based on the test electricity generation data set to obtain a model evaluation value;
S204, judging whether the model evaluation value is not less than a model evaluation threshold, if so, taking the periodic distribution characteristic prediction model as the optimal periodic distribution characteristic prediction model. Otherwise, regrouping the target historical electricity generation data to obtain a new parameter-adjusted electricity generation data set and a new test electricity generation data set, and performing S202 to S204 based on the new parameter-adjusted electricity generation data set and the new test electricity generation data set. When the newly model evaluation value is not less than the model evaluation threshold, taking the newly obtained periodic distribution characteristic prediction model as the optimal periodic distribution characteristic prediction model;
S205, obtaining predictive results based on the optimal periodic distribution characteristic prediction model.

Preferably, according to the method for simultaneously modeling electricity generation data and conducting visual analysis, S201: grouping the target historical electricity generation data to obtain a parameter-adjusted electricity generation data set and a test electricity generation data set includes:
acquiring a line chart of the target historical electricity generation data, and identifying period transformation points in data line chart;
dividing the line chart into multiple sub-line charts based on the period transformation points, and determining groups of electricity generation data based on these sub-line charts;
grouping electricity generation data according to a preset proportion to obtain a parameter-adjusted electricity generation data set and a test electricity generation data set.

Preferably, according to the method for simultaneously modeling electricity generation data and conducting visual analysis, acquiring a line chart of the target historical electricity generation data and identifying period transformation points in the line chart include:
sequentially taking each data point in the line chart as a reference data point, calculating the first deviation ratio of the reference data point to the rest of the data points, and summarizing all of the corresponding first deviation ratios of their reference data points to obtain a first deviation ratio set of each reference data point;
filtering a first deviation ratio subset from each first deviation ratio set based on a first deviation ratio threshold, and sorting the first deviation ratios contained in the first deviation ratio subset in an ascending order to obtain a first deviation ratio sequence of each reference data point;
identifying the period transformation points in the line chart based on similarity evaluation of the first deviation ratio sequence of all reference data points.

Preferably, according to the method for simultaneously modeling electricity generation data and conducting visual analysis, identifying the period transformation points in the line chart based on similarity evaluation of the first deviation ratio sequence of all reference data points includes:
calculating similarity evaluations of the first deviation ratio sequence of all reference data points, and judging whether the similarity evaluation is not less than a similarity evaluation threshold, if so, marking the reference data points corresponding to each first deviation ratio sequence and other data points corresponding to all of the first deviation ratios in the calculated first deviation ratio sequence in the line chart to obtain a marked line chart corresponding to each reference data point;
otherwise, deleting a last first-deviation ratio from the first deviation ratio sequence of all reference data points to obtain a new first deviation ratio sequence of each reference data point, and calculating similarity evaluation of the new first deviation ratio sequences of all reference data points, and when the newly obtained similarity evaluation is not less than the similarity evaluation threshold, marking the finally obtained reference data points corresponding to each first deviation ratio sequence and other data points corresponding to all of the first deviation ratios in the calculated first deviation ratio sequence in the line chart to obtain a marked line chart corresponding to each reference data point;
identifying the period transformation points in the line chart based on all marked line charts.

Preferably, according to the method for simultaneously modeling electricity generation data and conducting visual analysis, identifying the period transformation points in the line chart based on all marked line charts includes:
determining a first abscissa difference between adjacent marked points in each marked line chart, summarizing all of the first abscissa differences of all marked line charts to obtain an abscissa difference set, and judging whether there is a mode in the abscissa difference set, if so, taking the first abscissa difference corresponding to the mode as an interval period, otherwise, taking an average value of all of the first abscissa differences in the abscissa difference set after outliers are deleted as an interval period;
identifying the period transformation points in the line chart based on the interval period.

Preferably, according to the method for simultaneously modeling electricity generation data and conducting visual analysis, identifying the period transformation points in the line chart based on the interval period includes:
filtering data points corresponding to an abscissa value with a smallest difference from the abscissa difference corresponding to the interval period from the line chart as period division points;
taking all data points from initial data points to the period division points as hypothetical period initial points, determining a second abscissa difference between each data point and the hypothetical period initial points in the line chart, and taking the data point corresponding to the second abscissa difference with a smallest difference from the abscissa difference corresponding to the interval period among all of the second abscissa differences corresponding to the hypothetical period initial points as the period data point corresponding to the hypothetical period initial points;
calculating the difference between each hypothetical period initial point and the corresponding period data point, and summarizing all of the differences to obtain a difference set;
identifying the period transformation points in the line chart based on the difference set.

Preferably, according to the method for simultaneously modeling electricity generation data and conducting visual analysis, identifying the period transformation points in the line chart based on the difference set includes:
deleting outliers in the difference set to obtain a standard difference set, and taking the hypothetical period initial point with a smallest abscissa value in the standard difference set as a final period initial point;
determining a third abscissa difference between each data point after the period data point corresponding to the final period initial point and the period data point corresponding to the final period initial point in the line chart, and taking the data point corresponding to the third abscissa difference with a smallest difference from the abscissa difference corresponding to the interval period as a new period data point;
continuing to determine new period data points based on the newly obtained period data points, and when all period data points in the line chart are determined, taking the final period initial point and all period data points as period transformation points in the line chart.

Preferably, according to the method for simultaneously modeling electricity generation data and conducting visual analysis, S203: evaluating the periodic distribution characteristic prediction model based on the test electricity generation data set to obtain a model evaluation value includes:
inputting the test electricity generation data set into the periodic distribution characteristic prediction model to obtain a model prediction value corresponding to each value in the test electricity generation data set;
fitting a model prediction line chart corresponding to each group of electricity generation data based on all model prediction values corresponding to each group of electricity generation data in the test electricity generation data set;
determining a test electricity generation data line chart of each group of electricity generation data in the test electricity generation data set;
calculating a coincidence degree of the model prediction line chart corresponding to each group of electricity generation data and the test electricity generation data line chart and calculating the model evaluation value based on all the coincidence degrees.

Other features and advantages of the present disclosure will be set forth in the description which follows, and in part will be obvious from the description, or may be learned by practice of the present disclosure. The objectives and other advantages of the present disclosure can be realized and obtained by the structure particularly pointed out in the written specification and claims, as well as the accompanying drawings.

The technical scheme of the present disclosure will be further described in detail through the accompanying drawings and embodiments.

### BRIEF DESCRIPTION OF THE DRAWINGS

The accompanying drawings are provided to provide a further understanding of the present disclosure and constitute a part of the specification. Together with the embodiments of the present disclosure, the accompanying drawings serve to explain the present disclosure and do not constitute a limitation of the present disclosure.

FIG. 1 is a flowchart of a method for simultaneously modeling electricity generation data and conducting visual analysis according to an embodiment of the present disclosure.

FIG. 2 is a flowchart of another method for simultaneously modeling electricity generation data and conducting visual analysis according to an embodiment of the present disclosure.

FIG. 3 is a flowchart of another method for simultaneously modeling electricity generation data and conducting visual analysis according to an embodiment of the present disclosure.

### DETAILED DESCRIPTION OF THE EMBODIMENTS

Preferred embodiments of the present disclosure will be described with reference to the accompanying drawings hereinafter. It should be understood that the preferred embodiments described here are only used to illustrate and explain the present disclosure, rather than limit the present disclosure.

### Embodiment 1

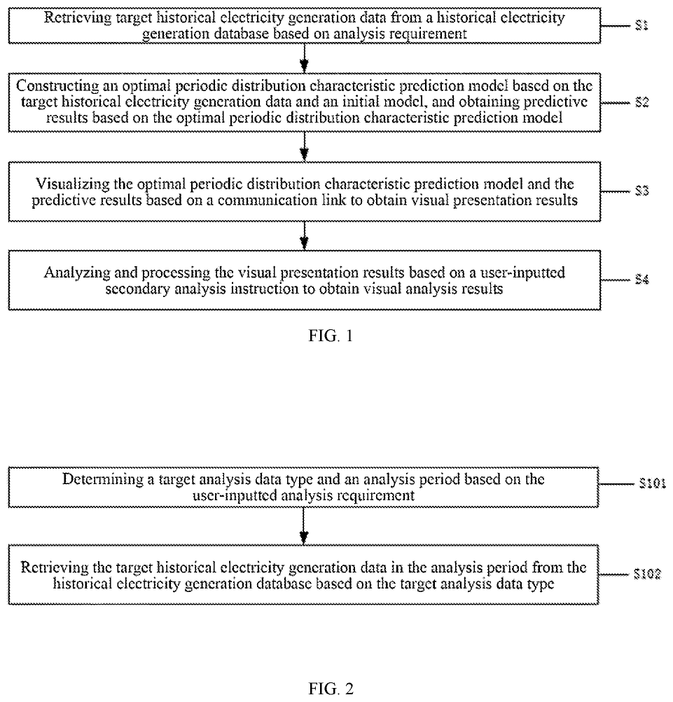

The present disclosure provides a method for simultaneously modeling electricity generation data and conducting visual analysis. As shown in FIG. 1, the method includes:
S1, retrieving target historical electricity generation data from a historical electricity generation database based on analysis requirement;
S2, constructing an optimal periodic distribution characteristic prediction model based on the target historical electricity generation data and an initial model, and obtaining predictive results based on the optimal periodic distribution characteristic prediction model;
S3, visualizing the optimal periodic distribution characteristic prediction model and the predictive results based on a communication link to obtain visual presentation results;
S4, analyzing and processing the visual presentation results based on a user-inputted secondary analysis instruction to obtain visual analysis results.

In this embodiment, the electricity generation data is the electricity generation amount at different times in a certain sampling period or the electricity demand amount in an electricity supply area.

In this embodiment, the analysis requirement is the user's requirement for electricity generation data analysis, for example, predicting the time-evolving data of electricity generation amount of an electricity plant in the future period.

In this embodiment, the historical electricity generation database is the database for storing the historical electricity generation data of an analysis object.

In this embodiment, the target historical electricity generation data is a certain type of historical electricity generation data retrieved from the historical electricity generation database based on the analysis requirement, including multiple values (i.e., electricity generation amount or electricity demand amount at different times), and it is also the original data used in the subsequent data modeling process and for predicting time-evolving electricity generation data in the next cycle.

In this embodiment, the initial model is represented by Q(t_{T}) as a function, t_{T} denotes the time variable in the T-th period, and Q(t_{T}) is a numerical value corresponding to the time t of the corresponding type of electricity generation data in the T-th period.

In this embodiment, the optimal periodic distribution characteristic prediction model is the optimal model that can predict the time-evolving data behavior of the corresponding type of electricity generation data in the future period after data modeling based on the target historical electricity generation data and the initial model.

In this embodiment, the predictive results are the predicted results based on the optimal periodic distribution characteristic prediction model, which contains the information such as the time when the peak value of the electricity generation data among the corresponding type of electricity generation data appears in the next cycle, the time-evolving data of the electricity generation data in the next cycle, and the periodicity of the electricity generation data in the next cycle.

In this embodiment, the communication link is a communication channel for transmitting the optimal periodic distribution characteristic prediction model obtained after data modeling to a visual presentation tool (or component) in real time.

In this embodiment, the visual presentation results are the results obtained by visualizing the optimal periodic distribution characteristic prediction model and the predictive results based on the communication link.

In this embodiment, the secondary analysis instruction is the user-inputted instruction for further analysis of the visual presentation results, and contains the strategy for further analysis.

In this embodiment, the visual analysis results are the results obtained by analyzing and processing the visual presentation results based on the user-inputted secondary analysis instruction.

In this embodiment, the visual presentation results are analyzed and processed based on the user-inputted secondary analysis instruction, and the visual analysis results are obtained, for example: the peak value of electricity generation data in the next cycle or the sum of electricity generation data in the next cycle is determined from the time-evolving data of electricity generation data of the predictive results in the next cycle.

The benefits from the above technique: retrieving target historical electricity generation data from a historical electricity generation database based on analysis requirement, modeling data based on the target historical electricity generation data and an initial model and obtaining a prediction model capable of accurately predicting the time-evolving behavior of electricity generation data in the next cycle. The present disclosure also facilitates the visualization of results obtained from the prediction model concerning the best periodic distribution characteristics. Furthermore, it enables further analytical processing of the visual results based on user-inputted analysis instructions. In doing so, it seamlessly integrates data modeling and visual analysis for electricity generation data. This not only empowers analysis of existing electricity generation data and the prediction of temporal variations in future cycles but also facilitates the visual representation of electricity generation data.

### Embodiment 2

On the basis of Embodiment 1, according to the method for simultaneously modeling electricity generation data and conducting visual analysis, as shown in FIG. 2, S1: retrieving target historical electricity generation data from a historical electricity generation database based on analysis requirement includes:
S101: determining a target analysis data type and an analysis period based on the user-inputted analysis requirement;
S102: retrieving the target historical electricity generation data in the analysis period from the historical electricity generation database based on the target analysis data type.

In this embodiment, the target analysis data type is the electricity generation data type that needs to be analyzed, which is determined based on the user-inputted analysis requirement, such as electricity generation amount or electricity demand amount.

In this embodiment, the analysis period is the period for retrieving the target historical electricity generation data determined based on the analysis requirement for input.

The benefits from the above technique: retrieving the target historical electricity generation data based on the target analysis data type and the analysis period in the user-inputted analysis requirement.

### Embodiment 3

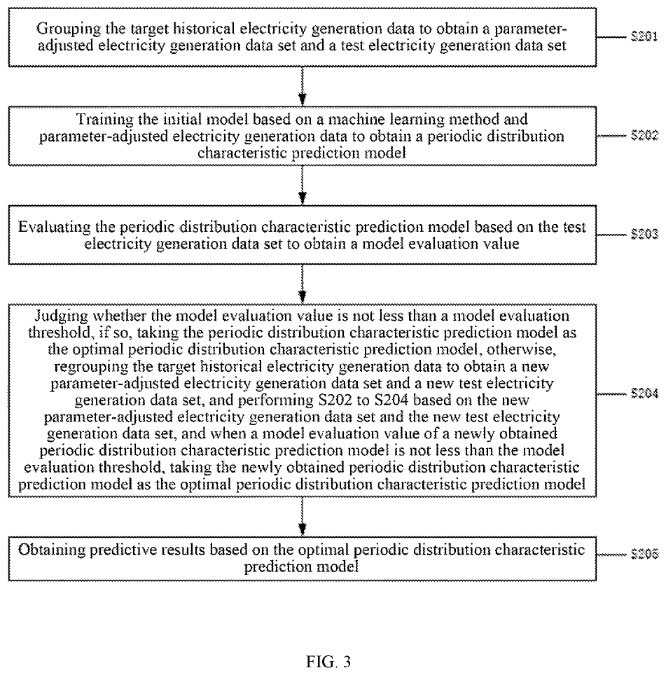

On the basis of Embodiment 1, according to the method for simultaneously modeling electricity generation data and conducting visual analysis, as shown in FIG. 3, S2: constructing an optimal periodic distribution characteristic prediction model based on the target historical electricity generation data and an initial model and obtaining predictive results based on the optimal periodic distribution characteristic prediction model includes:
S201, grouping the target historical electricity generation data to obtain a parameter-adjusted electricity generation data set and a test electricity generation data set;
S202, training the initial model based on a machine learning method and parameter-adjusted electricity generation data to obtain a periodic distribution characteristic prediction model;
S203, evaluating the periodic distribution characteristic prediction model based on the test electricity generation data set to obtain a model evaluation value;
S204, judging whether the model evaluation value is not less than a model evaluation threshold, if so, taking the periodic distribution characteristic prediction model as the optimal periodic distribution characteristic prediction model, otherwise, regrouping the target historical electricity generation data to obtain a new parameter-adjusted electricity generation data set and a new test electricity generation data set, and performing S202 to S204 based on the new parameter-adjusted electricity generation data set and the new test electricity generation data set, and when a model evaluation value of a newly obtained periodic distribution characteristic prediction model is not less than the model evaluation threshold, taking the newly obtained periodic distribution characteristic prediction model as the optimal periodic distribution characteristic prediction model;
S205, obtaining predictive results based on the optimal periodic distribution characteristic prediction model.

In this embodiment, the parameter-adjusted electricity generation data set is a electricity generation data set that is used to train the initial model after summarizing groups of electricity generation data (the number of groups is 0.8 times of the total number of groups of electricity generation data in the target historical electricity generation data) obtained by grouping the target historical electricity generation data according to 8:2.

In this embodiment, the test electricity generation data set is a electricity generation data set that is used to evaluate the periodic distribution characteristic prediction model after summarizing groups of electricity generation data (the number of groups is 0.2 times of the total number of groups of electricity generation data in the target historical electricity generation data) obtained by grouping the target historical electricity generation data.

In this embodiment, training the initial model based on a machine learning method and parameter-adjusted electricity generation data to obtain a periodic distribution characteristic prediction model is as follows:
each group of electricity generation data contained in the parameter-adjusted electricity generation data set is input into the initial model for continuous training based on the machine learning method to obtain a periodic distribution characteristic prediction model. The periodic distribution characteristic prediction model is represented by Q(tT), tT′ denotes the time variable in the T-th period, and Q(tT) is a numerical value corresponding to the time t of the corresponding type of electricity generation data in the T-th period in the expression corresponding to the periodic distribution characteristic prediction model.

In this embodiment, the model evaluation value is the evaluation value characterizing the prediction accuracy of the periodic distribution characteristic prediction model obtained by evaluating the periodic distribution characteristic prediction model based on the test electricity generation data. The larger the model evaluation value, the higher the prediction accuracy of the periodic distribution characteristic prediction model.

In this embodiment, the model evaluation threshold is the lowest model evaluation value that needs to be reached when it is determined that the periodic distribution characteristic prediction model is the optimal periodic distribution characteristic prediction model.

In this embodiment, the optimal periodic distribution characteristic prediction model is the optimal periodic distribution characteristic prediction model obtained after the data modeling process, and is also the periodic distribution characteristic prediction model in which the model evaluation value is not less than the model evaluation threshold. In this embodiment, regrouping the target historical electricity generation data means reordering groups of electricity generation data in the target historical electricity generation data, and regrouping according to 8:2 based on the plurality of groups of reordered electricity generation data.

The technology has the following beneficial effect: grouping, training, parameter adjustment and evaluation of the target historical generation data are realized until the data modeling process is completed, and the time-evolving data that can accurately predict the electricity generation data in the next cycle is obtained, so as to obtain accurate predictive results.

### Embodiment 4

On the basis of Embodiment 3, according to the method for simultaneously modeling electricity generation data and conducting visual analysis, S201: grouping the target historical electricity generation data to obtain a parameter-adjusted electricity generation data set and a test electricity generation data set includes:
acquiring a line chart of the target historical electricity generation data, and identifying period transformation points in the line chart;
dividing the line chart into multiple sub-line charts based on the period transformation points, and determining groups of electricity generation data based on these sub-line charts;
grouping the plurality of groups of electricity generation data according to a preset proportion to obtain a parameter-adjusted electricity generation data set and a test electricity generation data set.

In this embodiment, the line chart is a line chart containing all numerical values in the target historical electricity generation data.

In this embodiment, the period transformation point is the intersection of adjacent periods in the target historical electricity generation data contained in the line chart.

In this embodiment, the sub-line chart is a partial line chart obtained by dividing the line chart based on the period transformation point as the division point.

In this embodiment, the electricity generation data is the electricity generation data (consisted of a plurality of numerical values) corresponding to each sub-line chart in the target historical electricity generation data, and it is also the changing data of the electricity generation data in a single period.

In this embodiment, the preset ratio is 8:2, in which the total number of groups of grouped electricity generation data contained in the parameter-adjusted electricity generation data set is 0.8 times of the total number of groups of electricity generation data contained in the target historical electricity generation data, and the total number of groups of electricity generation data contained in the parameter-adjusted electricity generation data set is 0.2 times of the total number of groups of electricity generation data contained in the target historical electricity generation data.

The technology has the following beneficial effect: by identifying the period transformation points in the line chart corresponding to the target historical electricity generation data, the division reference position of the target historical electricity generation data divided according to the period is determined so as to obtain the electricity generation data of a plurality of periods, and groups of divided electricity generation data are grouped according to a preset ratio so as to obtain the parameter-adjusted electricity generation data set and the test electricity generation data set required for data modeling.

### Embodiment 5

On the basis of Embodiment 4, according to the method for simultaneously modeling electricity generation data and conducting visual analysis, acquiring a line chart of the target historical electricity generation data and identifying period transformation points in the line chart include:
sequentially taking each data point in the line chart as a reference data point, calculating a first deviation ratio of the reference data point to the rest of the data points, and summarizing all of the corresponding first deviation ratios of their reference data points to obtain a first deviation ratio set of each reference data point;
filtering a first deviation ratio subset from each first deviation ratio set based on a first deviation ratio threshold, and sorting the first deviation ratios contained in the first deviation ratio subset in an ascending order to obtain a first deviation ratio sequence of each reference data point;
identifying the period transformation points in the line chart based on similarity evaluation of the first deviation ratio sequence of all reference data points.

In this embodiment, the reference data point is the currently calculated data point contained in the line chart which needs to calculate the first deviation ratio of the reference data point to each remaining data point when calculating the first deviation ratio.

In this embodiment, the first deviation ratio is the ratio of the difference between the numerical value of each remaining data point except the reference data point in the line chart and the numerical value of the reference data point to the numerical value of the reference data point.

In this embodiment, the first deviation ratio set is the set obtained by summarizing all of the corresponding first deviation ratios of their reference data points.

In this embodiment, the first deviation ratio threshold is the preset threshold for filtering the first deviation ratio subset from the first deviation ratio set.

In this embodiment, the first deviation ratio subset is selected from each first deviation ratio set based on the first deviation ratio threshold, namely:
filtering the first deviation ratio whose first deviation ratio does not exceed the first deviation ratio threshold from the first deviation ratio set, and summarizing the filtered first deviation ratios which do not exceed the first deviation ratio threshold to obtain a first deviation ratio subset.

In this embodiment, the first deviation ratio sequence is a sequence obtained by sorting the first deviation ratios contained in the first deviation ratio subset in an ascending order.

In this embodiment, the similarity evaluation value is the numerical value used to evaluate the similarity of the first deviation ratio sequence of all reference data points. The greater the similarity evaluation value, the higher the similarity of the first deviation ratio sequence of all reference data points, and vice versa.

The technology has the following beneficial effect: by calculating the first deviation ratio of each data point to all other data points in the line chart, and based on the similarity evaluation between sequences obtained by sorting all the filtered third deviation ratios that do not exceed the first deviation ratio threshold, the period transformation points in the line chart can be accurately identified.

### Embodiment 6

On the basis of Embodiment 5, according to the method for simultaneously modeling electricity generation data and conducting visual analysis, identifying the period transformation points in the line chart based on similarity evaluation of the first deviation ratio sequence of all reference data points includes:
calculating similarity evaluation of the first deviation ratio sequence of all reference data points, and judging whether the similarity evaluation is not less than a similarity evaluation threshold, if so, marking the reference data points corresponding to each first deviation ratio sequence and other data points corresponding to all of the first deviation ratios in the calculated first deviation ratio sequence in the line chart to obtain a marked line chart corresponding to each reference data point;
otherwise, deleting a last first deviation ratio in the first deviation ratio sequence of all reference data points to obtain a new first deviation ratio sequence of each reference data point, and calculating similarity evaluation of the new first deviation ratio sequences of all reference data points, and when the newly obtained similarity evaluation is not less than the similarity evaluation threshold, marking the finally obtained reference data points corresponding to each first deviation ratio sequence and other data points corresponding to all of the first deviation ratios in the calculated first deviation ratio sequence in the line chart to obtain a marked line chart corresponding to each reference data point;
identifying the period transformation points in the line chart based on all marked line charts.

In this embodiment, calculating the similarity evaluation of the first deviation ratio sequence of all reference data points includes:

$${p}_{xs} = 1 - \frac{1}{m ( n - 1 )} {\sum }_{i = 2}^{n} {\sum }_{j = 1}^{m} \vert \frac{{p}_{ij} - {p}_{i ( j - 1 )}}{{p}_{ij}} \vert$$

where pₓₛ is the similarity evaluation of the first deviation ratio sequence of all reference data points, n is the total number of reference data points, m is the total number of numerical values contained in the first deviation ratio sequence, i is the i-th reference data point, j is the j-th first deviation ratio in the first deviation ratio sequence, pᵢⱼ is the j-th first deviation ratio in the first deviation ratio sequence of the i-th reference data point, and pi(j−1) is the (j−1)-th first deviation ratio in the first deviation ratio sequence of the i-th reference data point.

Based on the above formula, the similarity evaluation of the first deviation ratio sequence of all reference data points can be accurately calculated. In this embodiment, the similarity evaluation threshold is the threshold used to filter the data points corresponding to the marked points in the line chart.

In this embodiment, the marked line chart is a line chart obtained by marking the reference data points corresponding to each of the third deviation ratio sequences and other data points corresponding to all of the third deviation ratios in the calculated third deviation ratio sequence in the line chart.

The technology has the following beneficial effect: further judging and filtering the third deviation ratio sequence based on the similarity evaluation of the third deviation ratio sequence of all reference data points, so that the marked points in the finally obtained marked line chart are more likely to be period transformation points, and further the accuracy of identifying the period transformation points is improved.

### Embodiment 7

On the basis of Embodiment 6, according to the method for simultaneously modeling electricity generation data and conducting visual analysis, identifying the period transformation points in the line chart based on all marked line charts includes:
determining a first abscissa difference between adjacent marked points in each marked line chart, summarizing all of the first abscissa differences of all marked line charts to obtain an abscissa difference set, and judging whether there is a mode in the abscissa difference set, if so, taking the first abscissa difference corresponding to the mode as an interval period, otherwise, taking an average value of all of the first abscissa differences in the abscissa difference set after outliers are deleted as an interval period;
identifying the period transformation points in the line chart based on the interval period.

In this embodiment, the first abscissa difference is the abscissa difference between adjacent marked points in the marked line chart, and it is also the time interval between the adjacent marked points.

In this embodiment, the marked points are the reference data points corresponding to the finally obtained corresponding third deviation ratio sequence and other data points corresponding to all of the third deviation ratios in the calculated deviation ratio sequence.

In this embodiment, the abscissa difference set is the set obtained by summarizing all of the first abscissa differences in the marked line chart.

In this embodiment, the interval period is the period corresponding to the periodicity of the corresponding type of electricity generation data analyzed by the present disclosure, and it is also the interval time corresponding to the first abscissa difference corresponding to the mode or the average value of the time intervals corresponding to all of the first abscissa differences in the abscissa difference set after outliers are deleted.

The technology has the following beneficial effect: taking the mode in the first abscissa difference between all adjacent marked points in all marked line charts or the average value of all of the first abscissa differences in the abscissa difference set after outliers are deleted as the interval period, so that the period corresponding to the periodicity of electricity generation data can be accurately determined.

### Embodiment 8

On the basis of Embodiment 7, according to the method for simultaneously modeling electricity generation data and conducting visual analysis, identifying the period transformation points in the line chart based on the interval period includes:
filtering data points corresponding to an abscissa value with a smallest difference from the abscissa difference corresponding to the interval period from the line chart as period division points;
taking all data points from initial data points to the period division points as hypothetical period initial points, determining a second abscissa difference between each data point and the hypothetical period initial points in the line chart, and taking the data point corresponding to the second abscissa difference with a smallest difference from the abscissa difference corresponding to the interval period among all of the second abscissa differences corresponding to the hypothetical period initial points as the period data point corresponding to the hypothetical period initial points;
calculating the difference between each hypothetical period initial point and the corresponding period data point, and summarizing all of the differences to obtain a difference set;
identifying the period transformation points in the line chart based on the difference set.

In this embodiment, the period division point is the data point corresponding to the abscissa with a smallest difference from the abscissa difference corresponding to the interval period in the line chart.

In this embodiment, the hypothetical period initial points are all data points from the initial data point to the period division point.

In this embodiment, the second abscissa difference is the abscissa difference between each data point in the line chart and the hypothetical period initial point.

In this embodiment, the initial data point is the first data point in the line chart.

In this embodiment, the period data point is as follows: the time when the data points corresponding to the hypothetical period initial points are in the period to which the data points belong is t0, the period data point of the data point is the data point at t0 in other periods.

In this embodiment, the calculated difference between each hypothetical period initial point and the corresponding period data point is the difference between the numerical value corresponding to each hypothetical period initial point and the corresponding numerical value of their period data point.

In this embodiment, the difference set is the set obtained by summarizing the differences between all hypothetical period initial points and corresponding period data points.

The technology has the following beneficial effect: taking all data points in the duration corresponding to the first interval period in the line chart as the hypothetical period initial points, calculating the second abscissa difference between each data point and the hypothetical period initial point, filtering the period data points of each data point, and accurately identifying the period transformation points in the line chart based on the set of the differences between the numerical value of each hypothetical period initial point and the numerical value of the corresponding period data point.

### Embodiment 9

On the basis of Embodiment 8, according to the method for simultaneously modeling electricity generation data and conducting visual analysis, identifying the period transformation points in the line chart based on the difference set includes:
deleting outliers in the difference set to obtain a standard difference set, and taking the hypothetical period initial point with a smallest abscissa value in the standard difference set as a final period initial point;
determining a third abscissa difference between each data point after the period data point corresponding to the final period initial point and the period data point corresponding to the final period initial point in the line chart, and taking the data point corresponding to the third abscissa difference with a smallest difference from the abscissa difference corresponding to the interval period as a new period data point;
continuing to determine new period data points based on the newly obtained period data points, and when all period data points in the line chart are determined, taking the final period initial point and all period data points as period transformation points in the line chart.

In this embodiment, the standard difference set is the set obtained by summarizing all the remaining differences after the outliers in the difference set are deleted.

In this embodiment, the final period initial point is the hypothetical period initial point with the smallest abscissa value in the standard difference set, and it is also the initial data point of the first complete period in the line chart.

In this embodiment, the third abscissa difference is the abscissa difference between each data point after the period data point corresponding to the final period initial point determined in the line chart and the period data point corresponding to the final period initial point.

The technology has the following beneficial effect: taking the hypothetical period initial point with the smallest abscissa value in the standard difference set obtained by deleting outliers in the difference set as the final period initial point, determining all corresponding period data points in the line chart based on the final period initial point and its period data points, and taking the final period initial point and all period data points as the period transformation points in the line chart, thus further ensuring the accuracy of the determined period transformation points.

### Embodiment 10

On the basis of Embodiment 3, according to the method for simultaneously modeling electricity generation data and conducting visual analysis, S203: evaluating the periodic distribution characteristic prediction model based on the test electricity generation data set to obtain a model evaluation value includes:
inputting the test electricity generation data set into the periodic distribution characteristic prediction model to obtain a model prediction value corresponding to each value in the test electricity generation data set;
fitting a model prediction line chart corresponding to each group of electricity generation data based on all model prediction values corresponding to each group of electricity generation data in the test electricity generation data set;
determining a test electricity generation data line chart of each group of electricity generation data in the test electricity generation data set;
calculating a coincidence degree of the model prediction line chart corresponding to each group of electricity generation data and the test electricity generation data line chart, and calculating the model evaluation value based on all the coincidence degrees.

In this embodiment, the test electricity generation data set is input into the periodic distribution characteristic prediction model to obtain a model prediction value corresponding to each value in the test electricity generation data set, which is as follows.

The specific numerical value of t_{T} is determined based on the period ordinal number corresponding to each group of electricity generation data in the test electricity generation data set (that is, the numerical value characterizing which period the next cycle is) and the time corresponding to each numerical value in each group of electricity generation data. After the specific numerical value of t_{T} is substituted into the function Q(t_{T}) corresponding to the periodic distribution characteristic prediction model, the corresponding model prediction value of their numerical value in the corresponding group of electricity generation data in the test electricity generation data set, that is, the numerical value of Q(t_{T}), is obtained.

In this embodiment, the model prediction value is the prediction value of the corresponding numerical value in the test electricity generation data set predicted after the test electricity generation data set is input into the periodic distribution characteristic prediction model.

In this embodiment, the model prediction line chart is a line chart fitted by all the model prediction values corresponding to each group of electricity generation data in the test electricity generation data set.

In this embodiment, the test electricity generation data line chart is a line chart fitted based on the numerical values in each group of electricity generation data in the test electricity generation data set.

In this embodiment, calculating a coincidence degree of the model prediction line chart corresponding to each group of electricity generation data and the test electricity generation data line chart includes:

$$c = 1 - \frac{1}{q} {\sum }_{p = 1}^{q} \vert \frac{{x}_{1 p} - {x}_{2 p}}{{x}_{1 p}} \vert$$

where c is the coincidence degree between the model prediction line chart corresponding to each group of electricity generation data and the test electricity generation data line chart, p is the p-th numerical value contained in each group of electricity generation data, q is the total number of numerical values contained in each group of electricity generation data, x₁ₚ is the corresponding numerical value of the p-th numerical value contained in each group of electricity generation data in the model prediction line chart, and x₂ₚ is the corresponding numerical value of the p-th numerical value contained in each group of electricity generation data in the test electricity generation data line chart.

Based on the above formula, the coincidence degree between the model prediction line corresponding to each group of electricity generation data chart and the test electricity generation data line chart can be accurately calculated.

In this embodiment, the model evaluation value calculated based on all coincidence degrees is to take the average value of all coincidence degrees as the model evaluation value.

The technology has the following beneficial effect: the model evaluation of the periodic distribution characteristic prediction model is completed based on the coincidence degree between the model prediction line chart corresponding to each group of electricity generation data fitted by the model prediction value obtained after inputting the test electricity generation data set into the periodic distribution characteristic prediction model and the test electricity generation data line chart corresponding to each group of electricity generation data in the test electricity generation data set.

Obviously, those skilled in the art can make various modifications and variations to the present disclosure without departing from the spirit and scope of the present disclosure. Thus, the present disclosure intends to include these modifications and variations provided that these modifications and variations of the present disclosure fall within the scope of the claims and their equivalents.

1. A method for simultaneously modeling electricity generation data and conducting visual analysis, comprising:
S1, retrieving target historical electricity generation data obtained by a sensor installed in an electricity plant from a historical electricity generation database based on analysis requirement;
S2, constructing an optimal periodic distribution characteristic prediction model based on the target historical electricity generation data and an initial model, and obtaining predictive results based on the optimal periodic distribution characteristic prediction model;
S3, visualizing the optimal periodic distribution characteristic prediction model and the predictive results based on a communication link to obtain visual presentation results; and
S4, analyzing and processing the visual presentation results based on a user-inputted secondary analysis instruction to obtain visual analysis results;
wherein S2, constructing an optimal periodic distribution characteristic prediction model based on the target historical electricity generation data and an initial model, and obtaining predictive results based on the optimal periodic distribution characteristic prediction model, comprises:
S201, grouping the target historical electricity generation data to obtain a parameter-adjusted electricity generation data set and a test electricity generation data set;
S202, training the initial model based on a machine learning method and parameter-adjusted electricity generation data to obtain a periodic distribution characteristic prediction model;
S203, evaluating the periodic distribution characteristic prediction model based on the test electricity generation data set to obtain a model evaluation value;
S204, judging whether the model evaluation value is not less than a model evaluation threshold, if so, taking the periodic distribution characteristic prediction model as the optimal periodic distribution characteristic prediction model, otherwise, regrouping the target historical electricity generation data to obtain a new parameter-adjusted electricity generation data set and a new test electricity generation data set, and performing S202 to S204 based on the new parameter-adjusted electricity generation data set and the new test electricity generation data set, and when a model evaluation value of a newly obtained periodic distribution characteristic prediction model is not less than the model evaluation threshold, taking the newly obtained periodic distribution characteristic prediction model as the optimal periodic distribution characteristic prediction model; and
S205, obtaining predictive results based on the optimal periodic distribution characteristic prediction model;
wherein S201, grouping the target historical electricity generation data to obtain a parameter-adjusted electricity generation data set and a test electricity generation data set, comprises:
acquiring a line chart of the target historical electricity generation data, and identifying period transformation points in the line chart;
dividing the line chart into multiple sub-line charts based on the period transformation points, and determining groups of electricity generation data based on these sub-line charts; and
grouping the plurality of groups of electricity generation data according to a preset proportion to obtain a parameter-adjusted electricity generation data set and a test electricity generation data set.

2. The method for simultaneously modeling electricity generation data and conducting visual analysis according to claim 1, wherein S1, retrieving target historical electricity generation data from a historical electricity generation database based on analysis requirement, comprises:
S101: determining a target analysis data type and an analysis period based on the user-inputted analysis requirement; and
S102: retrieving the target historical electricity generation data in the analysis period from the historical electricity generation database based on the target analysis data type.

3. The method for simultaneously modeling electricity generation data and conducting visual analysis according to claim 1, wherein acquiring a line chart of the target historical electricity generation data and identifying period transformation points in the line chart comprises:
sequentially taking each data point in the line chart as a reference data point, calculating a first deviation ratio of the reference data point to the rest of the data points, and summarizing all of the corresponding first deviation ratios of their reference data points to obtain a first deviation ratio set of each reference data point;
filtering a first deviation ratio subset from each first deviation ratio set based on a first deviation ratio threshold, and sorting the first deviation ratios contained in the first deviation ratio subset in an ascending order to obtain a first deviation ratio sequence of each reference data point; and
identifying the period transformation points in the line chart based on similarity evaluation of the first deviation ratio sequence of all reference data points.

4. The method for simultaneously modeling electricity generation data and conducting visual analysis according to claim 3, wherein identifying the period transformation points in the line chart based on similarity evaluation of the first deviation ratio sequence of all reference data points comprises:
calculating similarity evaluation of the first deviation ratio sequence of all reference data points, and judging whether the similarity evaluation is not less than a similarity evaluation threshold, if so, marking the reference data points corresponding to each first deviation ratio sequence and other data points corresponding to all of the first deviation ratios in the calculated first deviation ratio sequence in the line chart to obtain a marked line chart corresponding to each reference data point;
otherwise, deleting a last first deviation ratio in the first deviation ratio sequence of all reference data points to obtain a new first deviation ratio sequence of each reference data point, and calculating similarity evaluation of the new first deviation ratio sequences of all reference data points, and when the newly obtained similarity evaluation is not less than the similarity evaluation threshold, marking the finally obtained reference data points corresponding to each first deviation ratio sequence and other data points corresponding to all of the first deviation ratios in the calculated first deviation ratio sequence in the line chart to obtain a marked line chart corresponding to each reference data point; and
identifying the period transformation points in the line chart based on all marked line charts.

5. The method for simultaneously modeling electricity generation data and conducting visual analysis according to claim 4, wherein identifying the period transformation points in the line chart based on all marked line charts comprises:
determining a first abscissa difference between adjacent marked points in each marked line chart, summarizing all of the first abscissa differences of all marked line charts to obtain an abscissa difference set, and judging whether there is a mode in the abscissa difference set, if so, taking the first abscissa difference corresponding to the mode as an interval period, otherwise, taking an average value of all of the first abscissa differences in the abscissa difference set after outliers are deleted as an interval period; and
identifying the period transformation points in the line chart based on the interval period.

6. The method for simultaneously modeling electricity generation data and conducting visual analysis according to claim 5, wherein identifying the period transformation points in the line chart based on the interval period comprises:
filtering data points corresponding to an abscissa value with a smallest difference from the abscissa difference corresponding to the interval period from the line chart as period division points;
taking all data points from initial data points to the period division points as hypothetical period initial points, determining a second abscissa difference between each data point and the hypothetical period initial points in the line chart, and taking the data point corresponding to the second abscissa difference with a smallest difference from the abscissa difference corresponding to the interval period among all of the second abscissa differences corresponding to the hypothetical period initial points as the period data point corresponding to the hypothetical period initial points;
calculating the difference between each hypothetical period initial point and the corresponding period data point, and summarizing all of the differences to obtain a difference set; and
identifying the period transformation points in the line chart based on the difference set.

7. The method for simultaneously modeling electricity generation data and conducting visual analysis according to claim 6, wherein identifying the period transformation points in the line chart based on the difference set comprises:
deleting outliers in the difference set to obtain a standard difference set, and taking the hypothetical period initial point with a smallest abscissa value in the standard difference set as a final period initial point;
determining a third abscissa difference between each data point after the period data point corresponding to the final period initial point and the period data point corresponding to the final period initial point in the line chart, and taking the data point corresponding to the third abscissa difference with a smallest difference from the abscissa difference corresponding to the interval period as a new period data point; and
continuing to determine new period data points based on the newly obtained period data points, and when all period data points in the line chart are determined, taking the final period initial point and all period data points as period transformation points in the line chart.

8. The method for simultaneously modeling electricity generation data and conducting visual analysis according to claim 1, wherein S203, evaluating the periodic distribution characteristic prediction model based on the test electricity generation data set to obtain a model evaluation value, comprises:
inputting the test electricity generation data set into the periodic distribution characteristic prediction model to obtain a model prediction value corresponding to each value in the test electricity generation data set;
fitting a model prediction line chart corresponding to each group of electricity generation data based on all model prediction values corresponding to each group of electricity generation data in the test electricity generation data set;
determining a test electricity generation data line chart of each group of electricity generation data in the test electricity generation data set; and
calculating a coincidence degree of the model prediction line chart corresponding to each group of electricity generation data and the test electricity generation data line chart, and calculating the model evaluation value based on all the coincidence degrees.
